(19) United States
(12) Patent Application Publication
(10) Pub. No.: US 2014/0026816 A1
(43) Pub. Date: Jan. 30, 2014

(54) MULTI-ZONE QUARTZ GAS DISTRIBUTION APPARATUS

(71) Applicant: APPLIED MATERIALS, INC., Santa Clara, CA (US)

(72) Inventors: NYI OO MYO, San Jose, CA (US); MEHMET TUGRUL SAMIR, Mountain View, CA (US)

(21) Appl. No.: 13/937,889

(22) Filed: Jul. 9, 2013

Related U.S. Application Data
(60) Provisional application No. 61/676,520, filed on Jul. 27, 2012.

(51) Int. Cl. B05B 9/03

(52) U.S. Cl. CPC B05B 9/03
USPC 118/728; 239/548

(57) ABSTRACT

Substrate processing apparatus and gas distribution apparatus are provided herein. In some embodiments, a gas distribution apparatus includes a first quartz layer having a plurality of openings disposed through the first quartz layer; a second quartz layer coupled to the first quartz layer; a first plenum fluidly coupled to a first set of the plurality of openings and disposed between the first quartz layer and the second quartz layer; a second plenum fluidly coupled to a second set of the plurality of openings and disposed between the first quartz layer and the second quartz layer; and one or more outlets disposed on a side of the gas distribution apparatus opposite the plurality of openings disposed through the first quartz layer to provide a gas to the side of the gas distribution apparatus opposite the first quartz layer.

### CROSS-REFERENCE TO RELATED APPLICATIONS

This application claims benefit of U.S. provisional patent application Ser. No. 61/676,520, filed Jul. 27, 2012, which is herein incorporated by reference.

### FIELD

Embodiments of the present invention generally relate to substrate processing apparatus, and more specifically to gas distribution apparatus for use in substrate processing apparatus.

### BACKGROUND

Deposition processes, such as epitaxial deposition processes and the like, can require control over a number of process parameters to ensure film quality. For example, such process parameters may include gas flow, temperature control, or the like.

The present invention provides improved gas distribution apparatus for use in deposition processes that may facilitate improved deposition of materials on a substrate.

### SUMMARY

Substrate processing apparatus and gas distribution apparatus for use therein are provided herein. In some embodiments, a gas distribution apparatus includes a first quartz layer having a plurality of openings disposed through the first quartz layer from a first side to an opposing second side of the first quartz layer; a second quartz layer coupled to the second side of the first quartz layer; a first plenum fluidly coupled to a first set of the plurality of openings and disposed between the first quartz layer and the second quartz layer; a second plenum fluidly coupled to a second set of the plurality of openings and disposed between the first quartz layer and the second quartz layer; and one or more outlets disposed on a side of the gas distribution apparatus opposite the plurality of openings disposed through the first quartz layer to provide a gas to the side of the gas distribution apparatus opposite the first quartz layer.

In some embodiments, a substrate processing apparatus includes a process chamber having a processing volume with a substrate support disposed therein; a gas distribution apparatus disposed above the substrate support to provide one or more gases to a substrate when disposed on the substrate support; and a gas injection system to provide the one or more gases to the gas distribution apparatus, wherein the gas injection system further includes a first injector disposed adjacent to the substrate support to conduct the one or more gases from an external gas source into the process chamber; and a second injector adjacent to the substrate support to conduct the one or more gases from the first injector to the gas distribution apparatus and to inject the one or more gases into the processing volume.

Other and further embodiments of the present invention are described below.

### BRIEF DESCRIPTION OF THE DRAWINGS

Embodiments of the present invention, briefly summarized above and discussed in greater detail below, can be understood by reference to the illustrative embodiments of the invention depicted in the appended drawings. It is to be noted, however, that the appended drawings illustrate only typical embodiments of this invention and are therefore not to be considered limiting of its scope, for the invention may admit to other equally effective embodiments.

FIG. 1A depicts a schematic side view of a substrate processing system in accordance with some embodiments of the present invention.

FIG. 1B depicts a schematic top view of a substrate processing system in accordance with some embodiments of the present invention.

FIG. 2A depicts a schematic cross sectional side view of a gas distribution apparatus in accordance with some embodiments of the present invention.

FIG. 2B depicts a schematic bottom view of a gas distribution apparatus in accordance with some embodiments of the present invention.

FIG. 2C depicts a schematic bottom view of a layer of a gas distribution apparatus in accordance with some embodiments of the present invention.

FIG. 3A depicts a schematic cross sectional side view of a gas distribution apparatus in accordance with some embodiments of the present invention.

FIG. 3B depicts a schematic bottom view of a gas distribution apparatus in accordance with some embodiments of the present invention.

FIG. 3C depicts a schematic top view of a layer of a gas distribution apparatus in accordance with some embodiments of the present invention.

FIG. 4 depicts a schematic cross sectional side view of a gas distribution apparatus in accordance with some embodiments of the present invention.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Gas distribution apparatus and methods of use are disclosed herein. Embodiments of the inventive gas distribution apparatus may advantageously provide separate control over individual process gases, such as using a multi-zonal configuration. Embodiments of the present invention may advantageously be retrofit to existing substrate processing apparatus without requiring substantial structural changes, such as providing flanges or the like in a wall of a process chamber to accommodate the gas distribution apparatus. Embodiments of the inventive gas distribution apparatus may be constructed of quartz, which may advantageously provide transparency to energy wavelengths used for heating, temperature monitoring or the like. Further, embodiments of gas distribution apparatus constructed substantially of quartz may provide reduced contamination as compared to metal-containing showerhead designs. The low thermal expansion coefficient of quartz may be suited to high temperature applications, such as epitaxial deposition processes or the like, where metal-containing showerhead designs may fail. Other and further advantages of the inventive apparatus are discussed below.

Embodiments of the inventive gas distribution apparatus disclosed herein may be used in any suitable process chamber, including those adapted for performing epitaxial deposition processes, such as any of the EPI® line of reactors, available from Applied Materials, Inc. of Santa Clara, Calif. It is contemplated that other process chambers may also benefit from gas distribution apparatus in accordance with the teachings herein, including chambers configured for other processes or chambers made by other manufacturers.

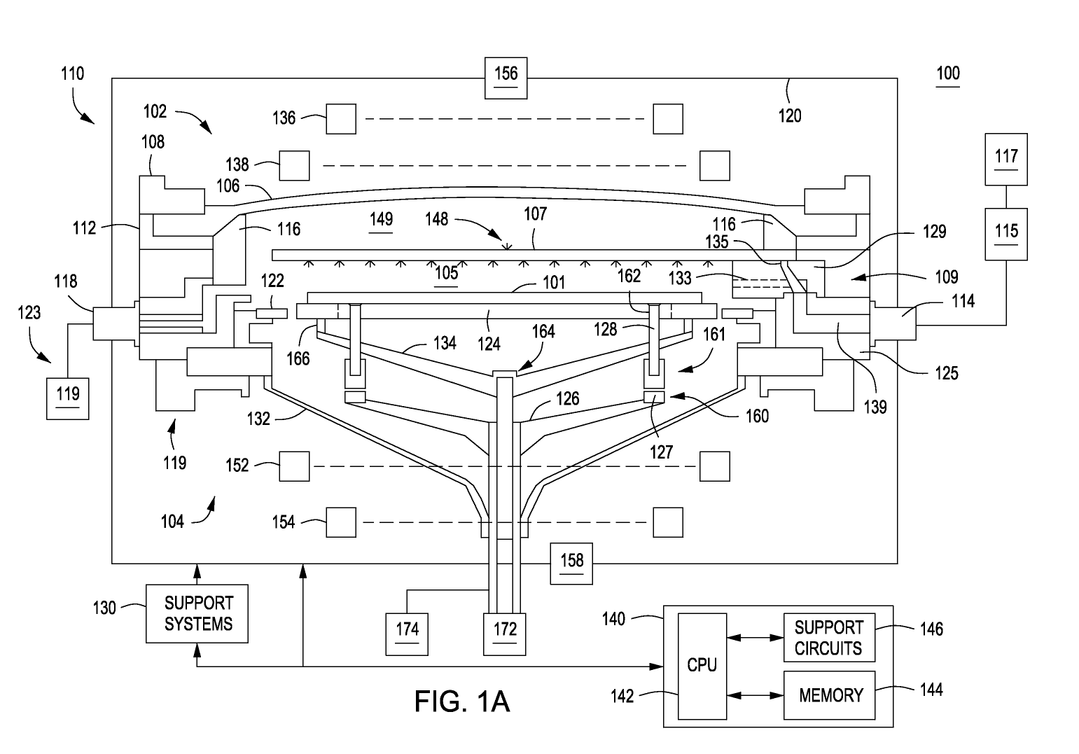

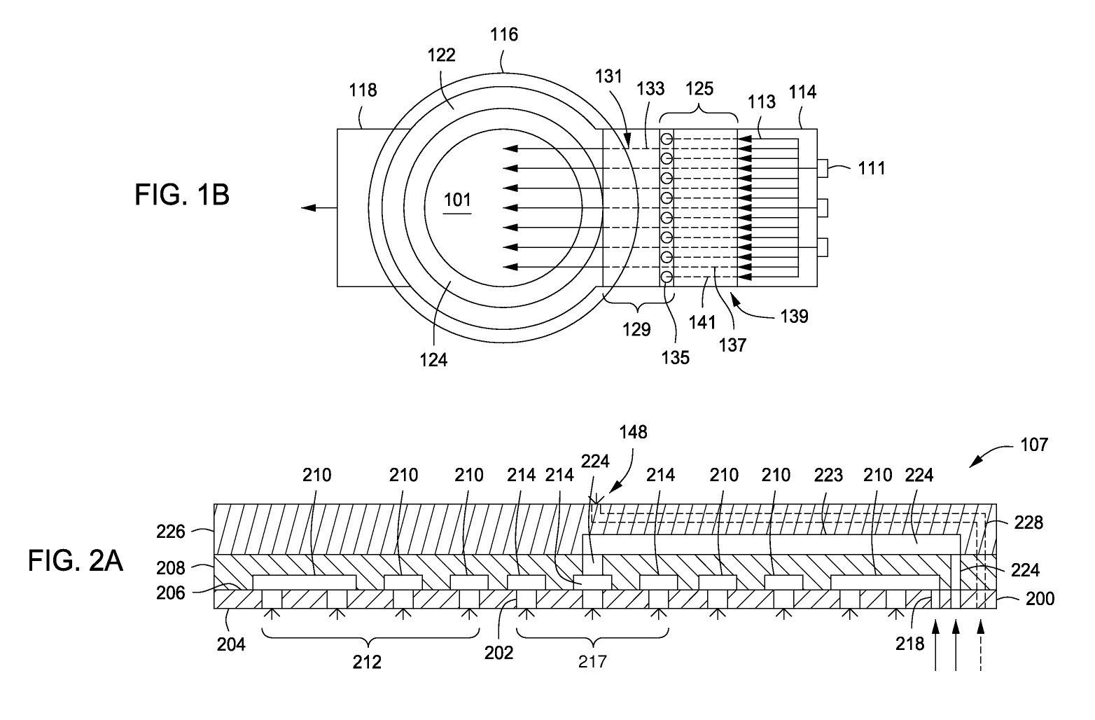

An exemplary process chamber is described below with respect to FIG. 1A, which depicts a schematic, cross-sectional view of a substrate processing apparatus 100 suitable for performing portions of the present invention. The substrate processing apparatus 100 may be adapted for performing epitaxial deposition processes and illustratively comprises a process chamber 110 having a processing volume 105 with a substrate support 124 disposed therein. The substrate processing apparatus 100 may include a gas distribution apparatus 107 disposed above the substrate support 124 to provide one or more gases to a substrate 101 when present on the substrate support 124 and a gas injection system 109 to provide the one or more gases to the gas distribution apparatus 107. The substrate processing apparatus may further include support systems 130, a controller 140, and additional features and/or components as discussed below. The substrate processing apparatus depicted in FIG. 1A is illustrative and the present inventive gas distribution apparatus may be utilized in other types of substrate processing apparatus.

The process chamber 110 generally includes an upper portion 102, a lower portion 104, and an enclosure 120. A vacuum system 123 may be coupled to the process chamber 110 to facilitate maintaining a desired pressure within the process chamber 110. In some embodiments, the vacuum system 123 may comprise a throttle valve (not shown) and vacuum pump 119 which are used to exhaust the process chamber 110. In some embodiments, the pressure inside the process chamber 110 may be regulated by adjusting the throttle valve and/or vacuum pump 119.

The upper portion 102 is disposed on the lower portion 104 and includes a lid 106, a clamp ring 108, a liner 116, a baseplate 112, one or more upper heating lamps 136 and one or more lower heating lamps 138, and an upper pyrometer 156. In some embodiments, the lid 106 has a dome-like form factor, however, lids having other form factors (e.g., flat or reverse curve lids) are also contemplated.

The lower portion 104 is coupled to a gas injection port 114 and an exhaust port 118 and comprises a lower dome 132, a substrate support 124, a pre-heat ring 122, a substrate lift assembly 160, a substrate support assembly 164, one or more upper heating lamps 152 and one or more lower heating lamps 154, and a lower pyrometer 158. Although the term “ring” is used to describe certain components of the substrate processing apparatus 100, such as the pre-heat ring 122, it is contemplated that the shape of these components need not be circular and may include any shape, including but not limited to, rectangles, polygons, ovals, and the like.

A gas source 117 may be coupled to the process chamber 110 to provide one or more process gases thereto. In some embodiments, a purifier 115 may be coupled to the gas source 117 to filter or purify the one or more process gases prior to entering the process chamber 110. The gas source 117 may provide one or more process gases. For example, the gas source 117 may be a gas manifold, or other suitable gas apparatus capable of providing one or more process gases separately, or in any desirable combinations to the processing volume 105.

The one or more process gases may enter the processing volume via the gas injection system 109 through the gas injection port 114. The gas injection port 114 may comprise metal or another gas compatible material. In some embodiments, the gas injection port 114 may include a plurality of inlets 111 coupled to a network of inlet conduits 113 to provide the one or more process gas to the gas injection system 109, as illustrated in FIG. 1B. The flow path provided by the plurality of inlets 111 and the network of inlet conduits 113 is merely exemplary for illustration and any desirable configuration of flow paths may be utilized, for example, such as each inlet 111 having an individual network of inlet conduits 113 coupled thereto to separately provide each process gas along independent flow paths.

The gas injection port 114 may further be an interchangeable part. For example, the gas injection port 114 may provide the one or more process gases in a specific configuration to the gas injection system 109. Accordingly, if a different configuration is desired, a second gas injection port 114 may be exchanged with the existing one to provide the new configuration to the gas injection system 109. Exemplary configurations of the gas injection port 114 may include different flow paths provided by the plurality of inlets 111 and the inlet conduits 113, such that when combined with the gas injection system 109, the one or more process gases may be provided to different regions of the processing volume 105. For example, the process gases may be flowed tangentially across the substrate 101, delivered from above the substrate, such as through the gas distribution apparatus 107, or combinations thereof. Further, configurations of the gas injection port 114 may be utilized to achieve any desirable spatial configuration of the one or more process gases to the substrate, such as towards the center of the substrate 101, proximate the periphery of the substrate 101, or spatially distributed on the substrate 101 in any desirable configuration.

As illustrated in FIGS. 1A-B, the gas injection system 109 may include a first injector 125 disposed adjacent to the substrate support 124 to conduct the one or more gases from an external gas source, e.g. the gas injection port 114 and/or the gas source 117, into the process chamber 110 and a second injector 129 disposed adjacent to the substrate support 124 to conduct the one or more gases from the first injector 125 to the gas distribution apparatus 107 and to inject the one more gases into the processing volume 105.

The second injector 129 may at least partially serve as a side injector for providing the one or more gases tangential to a processing surface of the substrate 101. As illustrated in FIG. 1 B, the second injector may include a first set 133 of a plurality of second injector conduits 131 to provide the one or more gases tangential to the processing surface of the substrate 101. The second injector may further include a second set 135 of the plurality of second injector conduits 131 to conduct the one or more gases from the first injector 125 to the gas distribution apparatus 107. The second injector 129 may comprise quartz or the like.

The first injector 125 may include a first set 137 of a plurality of first injector conduits 139 to provide the one or more gases from the gas injection port 114 to the first set 133 of the plurality of second injector conduits 131 of the second injector 129. Similarly, the first injector 125 may include a second set 141 of the plurality of first injector conduits 139 to provide the one or more gases from the gas injection port 114 to the second set 135 of the plurality of second injector conduits 131 of the second injector 129. The first injector 125 may be an interchangeable part, similar to the gas injection port 114 and for similar reasons. For example, the configurations of the first and second sets 137, 141 of the plurality of first injector conduits 139 may be varied to provide different spatially configurations of the one or more process gases, such as tangential across the processing surface of the substrate 101 through the first set 133 of the plurality of second injector conduits 131, and/or from above the substrate 101, such as through spatial zones disposed in the gas distribution apparatus 107 as discussed below. The first injector 125 may comprise quartz or the like.

The second set 135 of second injector conduits 131 may provide the one or more gases to the gas distribution apparatus 107 as illustrated in FIG. 1A. Although illustratively drawn in FIG. 1A as supported by the second injector 129, the gas distribution apparatus 107 may be supported in any suitable manner, such as configured to rest on the liner 116 and above the second injector 129 or the like. In addition, in some embodiments, the gas distribution apparatus 107 may further include one or more outlets 148 to provide a gas flow to a region 149 disposed between the gas distribution apparatus 107 and the lid 106. For example, a purge gas may be provided to the region 149 to limit or prevent unwanted deposition or other reactions from occurring in the region 149.

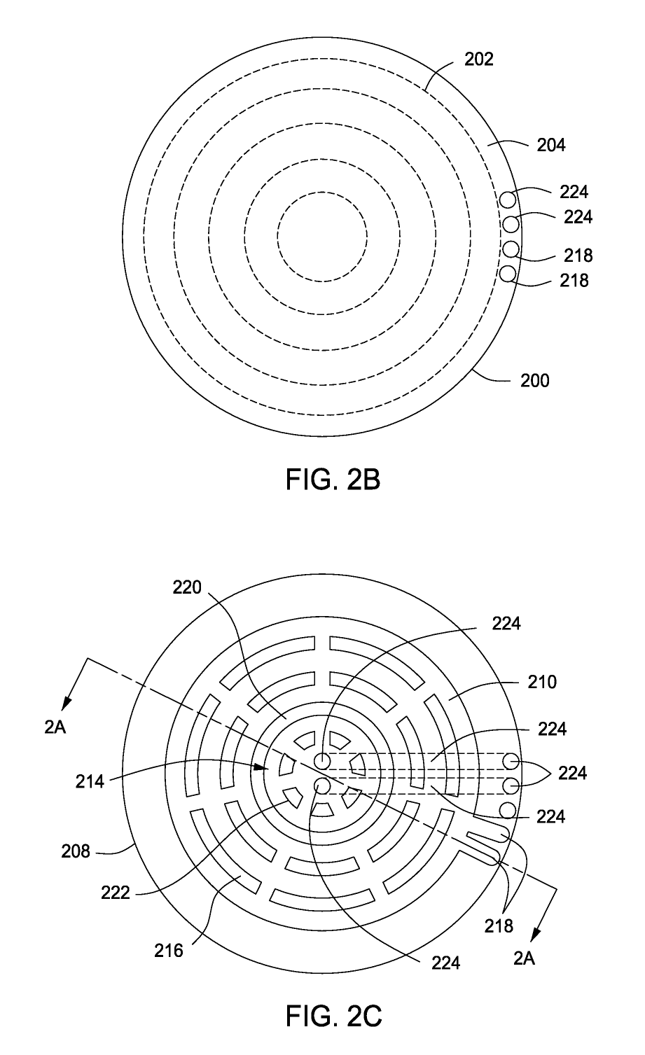

Embodiments of the gas distribution apparatus 107 are illustrated in further detail in FIGS. 2A-C and 3A-C. As illustrated in a cross sectional side view in FIG. 2A, the gas distribution apparatus 107 may comprise a plurality of layers. For example, the layers may comprise quartz. In some embodiments, the layers may be manufactured separately and then assembled and bonded together. For example, the layers may be bonded together sufficiently to seal all contacting surfaces together.

As illustrated in FIG. 2A, the gas distribution apparatus 107 may include a first quartz layer 200 having a plurality of openings 202 disposed through the first quartz layer 200 from a first side 204 to an opposing second side 206 of the first quartz layer 200. The plurality of openings 202 may be arranged in any desirable configuration to provide the one or more gases to the substrate 101. One exemplary arrangement of the plurality of openings 202 is illustrated in a schematic bottom view of the first quartz layer 200, as illustrate in FIG. 2B. As illustrated in FIG. 2B, the plurality of openings 202 are arranged in concentric rings, although other geometric arrangements may be used.

A second quartz layer 208 may be coupled to the second side 206 of the first quartz layer 200. The second quartz layer 208 may be bonded to the first quartz layer as discussed above. A first plenum 210 may be disposed between the first quartz layer 200 and a side of the second quartz layer 208 opposite the first quartz layer 200. The first plenum 210 may be fluidly coupled to a first set 212 of the plurality of openings 202. As illustrated in FIG. 1A, the first plenum 210 may be recessed into the second quartz layer 208 and capped by the second side 206 of the first quartz layer 200. However, this construction of the first plenum 210 is merely exemplary and other constructions are possible, such as forming the first plenum 210 partially in each of the first and second quartz layers 200, 208 or entirely within the second quartz layer 208.

Similarly, a second plenum 214 may be formed between the first quartz layer 200 and the side of the second quartz layer 208 opposite the first quartz layer 200. The second plenum 214 may be fluidly coupled to a second set 217 of the plurality of openings 202. The second plenum 214 may be constructed in any suitable manner between the first and second quartz layers 200, 208, similar to those embodiments discussed above for the first plenum 210. The first and second plenums 210, 214 may be utilized for providing different gases to different regions of the substrate 101, or alternatively providing the same gas at different flow rates to the substrate to different regions of the substrate 101.

In some embodiments, one or more conduits 228 may be provided to couple a gas source to one or more outlets 148 disposed on a side of the gas distribution apparatus 107 opposite the plurality of openings 202. For example, as depicted in FIG. 2A, the one or more outlets 148 may be disposed in a third quartz layer 226 coupled to the second quartz layer 208. The one or more outlets 148 may provide a gas, for example, a purge gas such as any process-compatible inert gas, to the region between the gas distribution apparatus 107 and the lid 106 (as depicted in FIG. 1A).

FIG. 2C, which depicts a schematic bottom view of the second quartz layer 208, depicts the first and second plenums 210, 214 in accordance with some embodiments of the present invention. For example, each of the first and second plenums 210, 214 may include walls disposed in the plenum to distribute an incoming gas evenly throughout the plenum. For example, a plurality of first walls 216 may be disposed in the first plenum to distribute a gas when flowing through the first plenum 210. As illustrated in FIG. 2C, the plurality of first walls 216 may be a plurality of concentrically arranged arc segments; however, other shapes and/or spatial arrangements of the plurality of first walls are possible. A gas may be fed into the first plenum 210 from a peripheral edge of the second quartz layer 208 via one or more first conduits 218, which are partially illustrated in FIG. 2C and further discussed below.

As shown in FIG. 2C, the second plenum 214 may be separated from the first plenum 210 by a continuous wall 220, which isolates the two plenums from each other. Similar to the first plenum 210, the second plenum 214 may include a plurality of second walls 222 disposed in the second plenum 214 to distribute a gas when flowing through the second plenum 214. As illustrated, the plurality of second walls 222 may be a plurality of arc segments arranged in a circular pattern; however, other shapes and/or arrangements of the plurality of second walls 222 are possible. A gas may be fed into the second plenum 214 via one or more second conduits 224, which are partially illustrated in FIG. 2C and further discussed below. Accordingly, as illustrated in FIG. 2C, a gas which enters the second plenum may be distributed outward towards the continuous wall 220. However, the manner in which the gas is fed into the second plenum is exemplary, and it may be possible to feed the gas into the second plenum from a position proximate the continuous wall 220.

Returning to FIGS. 2A-B, the one or more first conduits 218 may be disposed through the first quartz layer 200 from the first side 204 to the second side 206 and through the second quartz layer 208. Beginning on the first side 204 of the first quartz layer 200, the one or more first conduits 218 extend through the first quartz layer 200 from the first side 204 to the second side 206. Continuing in FIG. 2C, the one or more first conduits 218 may extend through the second quartz layer 208 where the one or more first conduits 218 may be fluidly coupled to the first plenum 210. The number and size of the first conduits 218 may be selected to control the desired flow rate and/or dispersion rate of a gas in the first plenum 210. As illustrated in FIGS. 2A-C, two first conduits 218 are shown.

Returning to FIG. 2A, the gas distribution apparatus may include a third quartz layer 226 coupled to the second quartz layer 208 on the side of the second quartz layer opposite the first quartz layer 200. The third quartz layer 226 may be bonded to the second quartz layer 208. The third quartz layer 226 may be utilized to at least partially form the one or more second conduits 224 which provide gas from the second injector 129 to the second plenum 214. For example, beginning on the first side 204 of the first quartz layer 200, the one or more second conduits 224 may extend through the first quartz layer 200 from the first side 204 to the second side 206 as illustrated in FIG. 2B. Continuing in FIG. 2C, the one or more second conduits 224 may extend through the second quartz layer 208 from a first side to a second side of the second quartz layer 208. The one or more second conduits 224 may be disposed through the third quartz layer 226 as illustrated in FIG. 2A (and shown in ghosted view in FIG. 2C) and extend into the second quartz layer 208 to the second plenum 214. For example, the one or more second conduits 224 may be fluidly coupled to the second plenum 214 through the third quartz layer 226. Similar to the one or more first conduits 218, the number and size of the second conduits 224 may be selected to control desired flow rate, dispersion rate of a gas in the second plenum 214 or the like. As illustrated in FIGS. 2A-C, two second conduits 224 are shown.

As illustrated in FIG. 2A, a portion 223 of one or more second conduits 224 disposed through the third quartz layer 226 is recessed into the third quartz layer 226 and capped by the opposing second quartz layer 208. Alternatively, the portion 223 of the one or more second conduits 224 may be disposed in the second quartz layer 208 and capped by the third quartz layer 226 or partially disposed in each of the second and third quartz layers 208, 226.

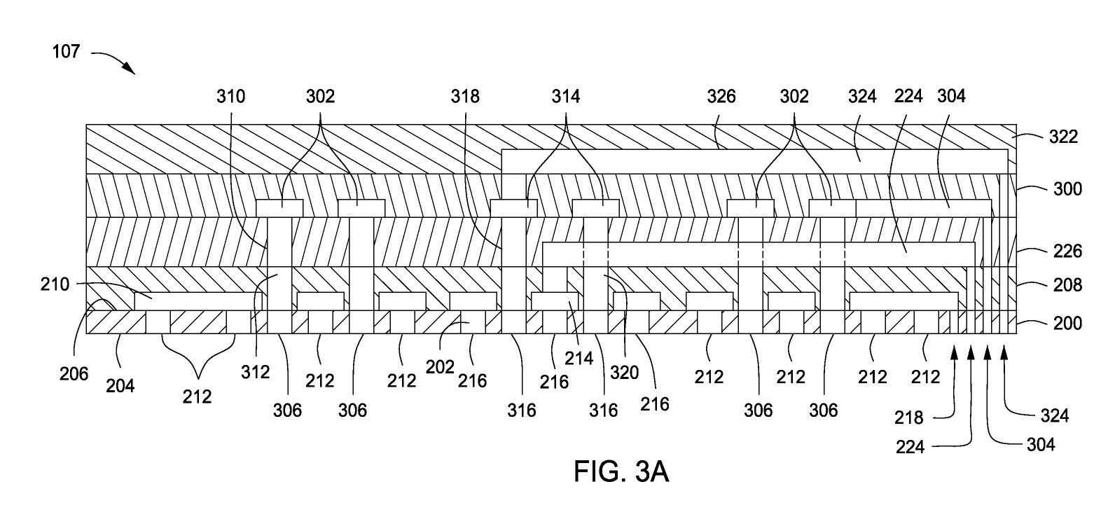

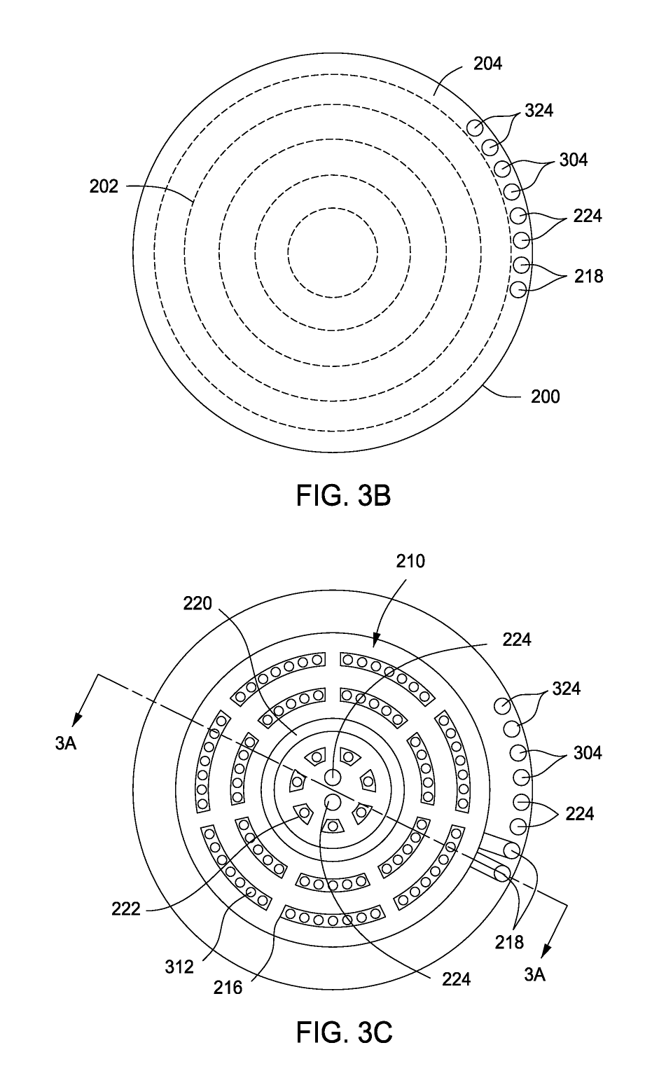

The embodiments of the gas distribution apparatus as illustrated in FIGS. 2A-C are merely one exemplary embodiment. Further embodiments of the gas distribution apparatus 107, which build upon the embodiments illustrated in FIGS. 2A-C, are illustrated in FIGS. 3A-C and discussed below.

For example, the gas distribution apparatus as illustrated in FIGS. 2A-C includes two zones, e.g., the first plenum 210 and the second plenum 214, which may be used to provide one gas at different rates, and/or different gases at the same or different rates. As illustrated in FIGS. 3A-C, the gas distribution apparatus may include additional layers which can be used to add additional zones. As illustrated in FIG. 3A-C, a fourth and fifth quartz layer are added to the gas distribution apparatus, which may be used to provide two additional zones to the gas distribution apparatus. The embodiments illustrated in FIGS. 3A-C are merely exemplary and further layers may be added to provide addition zones if desired.

FIG. 3A depicts a cross sectional side view of the gas distribution apparatus in accordance with some embodiments of the present invention. As illustrated in FIG. 3A, the gas distribution apparatus may include a fourth quartz layer 300 coupled to a side of the third quartz layer 226 opposite the second quartz layer 208. A third plenum 302 may be formed between the third quartz layer 226 and a side of the fourth quartz layer 300 opposite the third quartz layer 226. As illustrated in FIG. 3A, the third plenum 302 may be recessed into the fourth quartz layer 300 and capped by a side of the third quartz layer 226. However, the illustrated embodiment of the third plenum 302 is merely exemplary and the third plenum 302 may be partially disposed in each of the third and fourth quartz layers 226, 300 or entirely within the fourth quartz layer 300.

One or more third conduits 304 may be disposed through the first quartz layer 200 from the first side 204 to the second side 206 and extend through the second, third and fourth quartz layers 208, 226, 300 as illustrated in FIGS. 3A-B. The one or more third conduits 304 may be fluidly coupled to the third plenum 302 through the fourth quartz layer as illustrated in FIG. 3A. The one or more third conduits 304 may be substantially similar in structure as the one more first conduits 218, except extending upward through additional layers 208, 226 whereas the one or more first conduits 218 only extends upward through the first quartz layer 200.

The third plenum 302 may be fluidly coupled to a third set 306 of the plurality of the openings 202, as illustrated in FIGS. 3A. For example, the third plenum 300 may be fluidly coupled to the third set 306 via a plurality of conduits 310 disposed through the second and third quartz layers 208, 226. As illustrated in FIGS. 3A and 3C, the plurality of conduits 310 may include a plurality of first wall conduits 312 disposed through the plurality of first walls 216 of the first plenum 210 to fluidly couple the third plenum 300 to the third set 306 of the plurality of openings 202. The plurality of first wall conduits 312 can allow a gas from the third plenum 300 to pass through the first plenum 210 while remaining isolated from the first plenum 210. Although illustrated in FIG. 3C as passing through all of the plurality of first walls 216 of the first plenum 210 in the second quartz layer 208, the plurality of conduits 310 including the plurality of first wall conduits 312 may be arranged in any desirable configuration required of the application being performed in the process chamber 110. For example, the plurality of conduits 310 may be arranged such that the plurality of first wall conduits 312 passes through less than all of the plurality of first walls 216 and/or are disposed non-uniformly among each first wall 216 to achieve a desired process condition in the process chamber 110.

Returning to FIG. 3A, a fourth plenum 314 may be formed between the third quartz layer 226 and the side of the fourth quartz layer 300 opposite the third quartz layer 226. As illustrated in FIG. 3A, the fourth plenum 314 may be recessed into the fourth quartz layer 300 and capped by a side of the third quartz layer 226. However, the illustrated embodiment of the fourth plenum 314 is merely exemplary and the fourth plenum 314 may be partially disposed in each of the third and fourth quartz layers 226, 300 or entirely within the fourth quartz layer 300. The third and fourth plenums 302, 314 may be separated in a substantially similar manner as the first and second plenums 210, 214 are separated as discussed above.

The fourth plenum 314 may be fluidly coupled to a fourth set 316 of the plurality of the openings 202 as illustrated in FIGS. 3A. For example, the fourth plenum 314 may be fluidly coupled to the fourth set 316 via a plurality of conduits 318 disposed through the second and third quartz layers 208, 226. As shown in FIGS. 3A and 3C, the plurality of conduits 318 may include a plurality of second wall conduits 320 disposed through the plurality of second walls 222 of the second plenum 214 to fluidly couple the fourth plenum 314 to the fourth set 316 of the plurality of openings 202. The plurality of second wall conduits 320 can allow a gas from the fourth plenum 314 to pass through the second plenum 214 while remaining isolated from the second plenum 214. Although illustrated in FIG. 3C as passing through all of the plurality of second walls 222 of the second plenum 214 in the second quartz layer 208, the plurality of conduits 318 including the plurality of second wall conduits 320 may be arranged in any desirable configuration required of the application being performed in the process chamber 110. For example, the plurality of conduits 318 may be arranged such that the plurality of second wall conduits 320 passes through less than all of the plurality of second walls 222 and/or are disposed non-uniformly among each second wall 222 to achieve a desired process condition in the process chamber 110.

Returning again to FIG. 3A, a fifth quartz layer 322 may be coupled to the fourth quartz layer 300 on the side of the fourth quartz layer 300 opposite the third quartz layer 226. The fifth quartz layer 322 may provide a substantially similar function as the third quartz layer 226, e.g., to provide one or more of a conduit or capping layer to fluidly couple a gas to the fourth plenum 314. For example, one or more fourth conduits 324 may be disposed through the first quartz layer 200 from the first side 204 to the second side 206 and through the second, third, fourth, and fifth quartz layers 208, 226, 300, 322. The one or more fourth conduits 324 may be fluidly coupled to the fourth plenum 314 through the fifth quartz layer 322, such a through a portion 326 of the one or more fourth conduits 324 which extends through the fifth layer 322 as illustrated in FIG. 3A. Embodiments of the portion 326 may be similar to those of the portion 223 of the one or more second conduits 224.

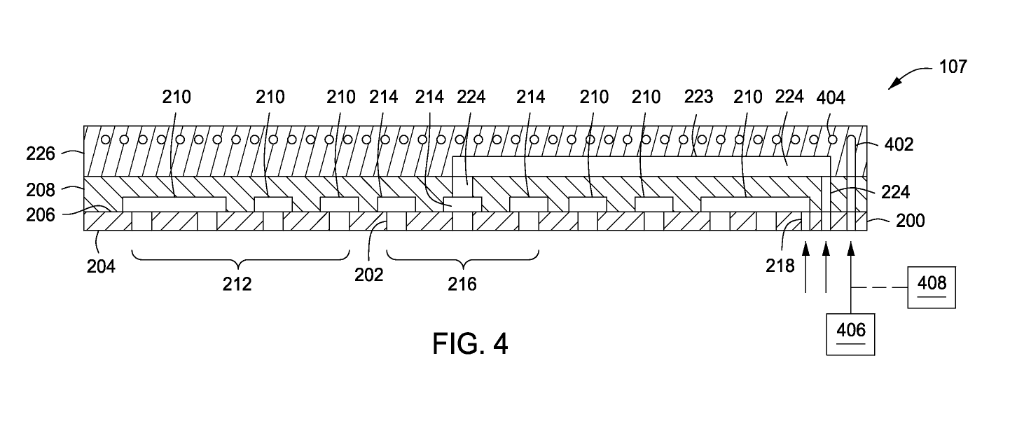

In some embodiments, and as depicted in FIG. 4, the temperature of the gases in the gas distribution apparatus 107 may be heated and/or cooled to control the temperature of the gases. For example, in some embodiments, one or more conduits 402 may be provided to couple a heat transfer fluid source 406 to one or more channels 404 disposed in the gas distribution apparatus 107. Although shown as being disposed above the plenums in FIG. 4, the one or more channels 404 may be disposed in other locations such as one or more of above, below, or in between the plenums of the gas distribution apparatus 107.

In some embodiments, a second heat transfer fluid source 408 may be coupled to a second one or more of the one or more channels 404. The second heat transfer fluid source 408 provides a heat transfer fluid maintained at a temperature different than that of the first heat transfer fluid. Alternatively, the second heat transfer fluid source 408 may be coupled to the same one or more channels 404 as the first heat transfer fluid source 406 and the first and second heat transfer fluid sources 406, 408 may selectively or proportionately provide respective heat transfer fluids at a desired temperature between the temperature of the first heat transfer fluid and the temperature of the second heat transfer fluid. Use of the first heat transfer fluid source 406 or of the first and second heat transfer fluid sources 406, 408 advantageously facilitates maintaining the gas distribution apparatus 107 at a desired temperature suitable for the process gases being delivered, thereby, for example, facilitating providing one or more of desired process gas temperature and/or activation.

Returning to FIG. 1, during processing, the substrate 101 is disposed on the substrate support 124. The lamps 136, 138, 152, and 154 are sources of infrared (IR) radiation (i.e., heat) and, in operation, generate a pre-determined temperature distribution across the substrate 101. The lid 106, the clamp ring 108, and the lower dome 132 are formed from quartz; however, other IR-transparent and process compatible materials may also be used to form these components.

The substrate support assembly 164 generally includes a support bracket 134 having a plurality of support pins 166 coupled to the substrate support 124. The substrate lift assembly 160 comprises a substrate lift shaft 126 and a plurality of lift pin modules 161 selectively resting on respective pads 127 of the substrate lift shaft 126. In one embodiment, a lift pin module 161 comprises an optional upper portion of the lift pin 128 is movably disposed through a first opening 162 in the substrate support 124. The substrate support assembly 164 further includes a lift mechanism 172 and a rotation mechanism 174 coupled to the substrate support assembly 164. The lift mechanism 172 can be utilized for moving the substrate support 124 along a central axis. For example, in operation, the substrate lift shaft 126 is moved to engage the lift pins 128. When engaged, the lift pins 128 may raise the substrate 101 above the substrate support 124 or lower the substrate 101 onto the substrate support 124. The rotation mechanism 174 can be utilized for rotating the substrate support 124 about the central axis.

The support systems 130 include components used to execute and monitor pre-determined processes (e.g., growing epitaxial films) in the substrate processing apparatus 100. Such components generally include various sub-systems. (e.g., gas panel(s), gas distribution conduits, vacuum and exhaust sub-systems, and the like) and devices (e.g., power supplies, process control instruments, and the like) of the substrate processing apparatus 100. These components are well known to those skilled in the art and are omitted from the drawings for clarity.

The controller 140 may be provided and coupled to the substrate processing apparatus 100 for controlling the components of the substrate processing apparatus 100. The controller 140 may be any suitable controller for controlling the operation of a substrate processing apparatus 100. The controller 140 generally comprises a Central Processing Unit (CPU) 142, a memory 144, and support circuits 146 and is coupled to and controls the substrate processing apparatus 100 and support systems 130, directly (as shown in FIG. 1) or, alternatively, via computers (or controllers) associated with the process chamber and/or the support systems.

The CPU 142 may be any form of a general purpose computer processor that can be used in an industrial setting. The support circuits 146 are coupled to the CPU 142 and may comprise cache, clock circuits, input/output subsystems, power supplies, and the like. Software routines, such as the methods for processing substrates disclosed herein, for example with respect to FIG. 2 below, may be stored in the memory 144 of the controller 140. The software routines, when executed by the CPU 142, transform the CPU 142 into a specific purpose computer (controller 140). The software routines may also be stored and/or executed by a second controller (not shown) that is located remotely from the controller 140. Alternatively or in combination, in some embodiments, for example where the substrate processing apparatus 100 is part of a multi-chamber processing system, each process chamber of the multi-chamber processing system may have its own controller for controlling portions of the inventive methods disclosed herein that may be performed in that particular process chamber. In such embodiments, the individual controllers may be configured similar to the controller 140 and may be coupled to the controller 140 to synchronize operation of the substrate processing apparatus 100.

While the foregoing is directed to embodiments of the present invention, other and further embodiments of the invention may be devised without departing from the basic scope thereof.

1. A gas distribution apparatus, comprising:
a first quartz layer having a plurality of openings disposed through the first quartz layer from a first side to an opposing second side of the first quartz layer;
a second quartz layer coupled to the second side of the first quartz layer;
a first plenum fluidly coupled to a first set of the plurality of openings and disposed between the first quartz layer and the second quartz layer;
a second plenum fluidly coupled to a second set of the plurality of openings and disposed between the first quartz layer and the second quartz layer; and
one or more outlets disposed on a side of the gas distribution apparatus opposite the plurality of openings disposed through the first quartz layer to provide a gas to the side of the gas distribution apparatus opposite the first quartz layer.

2. The gas distribution apparatus of claim 1, further comprising:
a plurality of first walls disposed in the first plenum to distribute a gas when flowing through the first plenum; and
a plurality of second walls disposed in the second plenum to distribute a gas when flowing through the second plenum.

3. The gas distribution apparatus of claim 1, further comprising:
one or more first conduits disposed through the first quartz layer from the first side to the second side and through the second quartz layer, wherein the one or more first conduits are fluidly coupled to the first plenum through the second quartz layer.

4. The gas distribution apparatus of claim 3, further comprising:
a third quartz layer coupled to the second quartz layer on the side of the second quartz layer opposite the first quartz layer; and
one or more second conduits disposed through the first quartz layer from the first side to the second side and through the second and third quartz layers, wherein the one or more second conduits are fluidly coupled to the second plenum through the third quartz layer.

5. The gas distribution apparatus of claim 4, further comprising:
a fourth quartz layer coupled to a side of the third quartz layer opposite the second quartz layer;
a third plenum formed between the third quartz layer and a side of the fourth quartz layer opposite the third quartz layer, wherein the third plenum is fluidly coupled to a third set of the plurality of the openings; and
a fourth plenum formed between the third quartz layer and the side of the fourth quartz layer opposite the third quartz layer, wherein the fourth is fluidly coupled to a fourth set of the plurality of the openings.

6. The gas distribution apparatus of claim 5, further comprising:
one or more third conduits disposed through the first quartz layer from the first side to the second side and through the second, third and fourth quartz layers, wherein the one or more conduits are fluidly coupled to the third plenum through the fourth quartz layer.

7. The gas distribution apparatus of claim 6, further comprising:
a fifth quartz layer coupled to the fourth quartz layer on the side of the fourth quartz layer opposite the third quartz layer; and
one or more fourth conduits disposed through the first quartz layer from the first side to the second side and through the second, third, fourth, and fifth quartz layers, wherein the one or more fourth conduits are fluidly coupled to the fourth plenum through the fifth quartz layer.

8. The gas distribution apparatus of claim 7, further comprising:
a plurality of first walls disposed in the first plenum to distribute a gas when flowing through the first plenum;
a plurality of first wall conduits disposed through the plurality of first walls to fluidly couple the third plenum to the third set of the plurality of openings;
a plurality of second walls disposed in the second plenum to distribute a gas when flowing through the second plenum; and
a plurality of second wall conduits disposed through the plurality of second walls to fluidly couple the fourth plenum to the fourth set of the plurality of openings.

9. The gas distribution apparatus of claim 1, further comprising:
a conduit disposed through the first quartz layer and fluidly coupled to the one or more outlets.

10. The gas distribution apparatus of claim 1, further comprising:
a conduit fluidly coupled to one or more channels disposed within the gas distribution apparatus to flow a heat transfer fluid through the one or more channels.

11. A substrate processing apparatus, comprising:
a process chamber having a processing volume with a substrate support disposed therein;
a gas distribution apparatus disposed above the substrate support to provide one or more gases to a substrate when disposed on the substrate support; and
a gas injection system to provide the one or more gases to the gas distribution apparatus, wherein the gas injection system further comprises:
a first injector disposed adjacent to the substrate support to conduct the one or more gases from an external gas source into the process chamber; and
a second injector adjacent to the substrate support to conduct the one or more gases from the first injector to the gas distribution apparatus and to inject the one or more gases into the processing volume.

12. The substrate processing apparatus of claim 11, wherein the second injector further comprises:
a first set of a plurality of second injector conduits to provide the one or more gases tangential to a surface of a substrate when present on the substrate support.

13. The substrate processing apparatus of claim 12, wherein the first injector further comprises:
a first set of a plurality of first injector conduits to provide the one or more gases from an external gas source to the first set of the plurality of second injector conduits.

14. The substrate processing apparatus of claim 12, wherein the second injector further comprises:
a second set of the plurality of second injector conduits to conduct the one or more gases from the first injector to the gas distribution apparatus.

15. The substrate processing apparatus of claim 14, wherein the first injector further comprises:
a second set of a plurality of first injector conduits to provide the one or more gases from an external gas source to the second set of the plurality of second injector conduits.

16. The substrate processing apparatus of claim 12, wherein the gas distribution apparatus further comprises:
a first quartz layer having a plurality of openings disposed through the first quartz layer from a first side facing the processing volume to an opposing second side of the first quartz layer;
a second quartz layer coupled to the second side of the first quartz layer;
a first plenum disposed between the first quartz layer and a side of the second quartz layer opposite the first quartz layer, wherein the first plenum is fluidly coupled to a first set of the plurality of openings; and
a second plenum formed between the first quartz layer and the side of the second quartz layer opposite the first quartz layer, wherein the second plenum is fluidly coupled to a second set of the plurality of openings.

17. The substrate processing apparatus of claim 16, wherein the gas distribution apparatus further comprises:
one or more first conduits disposed through the first quartz layer from the first side to the second side and through the second quartz layer, wherein the one or more conduits are fluidly coupled to the first plenum through the second quartz layer and wherein the one or more first conduits are coupled to one or more second injector conduits of the second set of the plurality of second injector conduits.

18. The substrate processing apparatus of claim 17, wherein the gas distribution apparatus further comprises:
a third quartz layer coupled to the second quartz layer on the side of the second quartz layer opposite the first quartz layer; and
one or more second conduits disposed through the first quartz layer from the first side to the second side and through the second and third quartz layers, wherein the one or more second conduits are fluidly coupled to the second plenum through the third quartz layer and wherein the one or more second conduits are coupled to one or more second injector conduits of the second set of the plurality of second injector conduits.

19. The substrate processing apparatus of claim 12, wherein the gas distribution apparatus further comprises:
one or more openings disposed on a side of the gas distribution apparatus opposite the substrate support to provide a gas to a region of the process chamber between the gas distribution apparatus and a lid of the process chamber.

20. The substrate processing apparatus of claim 12, wherein the gas distribution apparatus further comprises:
a conduit fluidly coupled to one or more channels disposed within the gas distribution apparatus to flow a heat transfer fluid therethrough.
